(19) United States
(12) Patent Application Publication
(10) Pub. No.: US 2023/0121369 A1
(43) Pub. Date: Apr. 20, 2023

(54) THE PROCESS FOR PRODUCTION OF A MEAT ANALOGUE, AND MEAT ANALOGUE PREPARED THEREBY

(71) Applicant: MARS, INCORPORATED, McLean, VA (US)

(72) Inventor: Johannes Paul SCHLEBUSCH, Verden (DE)

(73) Assignee: MARS, INCORPORATED, McLean, VA (US)

(21) Appl. No.: 17/908,758

(22) PCT Filed: Feb. 28, 2021
(86) PCT No.: PCT/EP2021/054954

§ 371 Date: Sep. 1, 2022

(30) Foreign Application Priority Data
Mar. 3, 2020 (DE) 10 2020 105 688.5

(51) Int. Cl. A23J 3/22; A23J 3/04; A23J 3/14; A23L 13/60; A23L 13/40

(52) U.S. Cl. CPC A23J 3/227; A23J 3/04; A23J 3/14; A23L 13/60; A23L 13/426; A23L 13/424

(57) ABSTRACT

The present invention provides a process for the production of a meat analogue, comprising the steps of: a) introducing a meat batter comprising i) animal protein other than egg powder, ii) plant fiber and/or starch, and iii) egg powder, into a heating unit and heating the meat batter to a temperature above the melting point of the protein to produce a heat-treated product, b) cooling the heat-treated product by moving through a cooling unit, so that the heat-treated product has a temperature below water boiling temperature at ambient pressure when exiting the cooling unit, and c) dividing the cooled heat-treated product into pieces.

The present invention relates to a process for the production of a meat analogue, a meat batter used in the process, and a meat analogue obtainable by this process.

Pet foods have long been manufactured from animal by-products and non-animal derived ingredients to prepare high quality food that provides the pet with the required nutrient profile without competing with the human food demand for meat. As the global population increases the global demand for high protein foods including meat is expected to increase, so an increasing need for pet foods prepared from meat analogues which meet the nutritional needs of pets is expected.

Meat analogues are typically prepared by mixing, chopping and emulsifying a mixture of raw meat ingredients such as beef, pork, lamb and chicken obtained from the muscle tissue and meat by-products. These raw meat ingredients are then mixed with various dry ingredients, for example vegetable by-products, starches, vitamins, minerals, gums, and glutens, to make a meat emulsion. The resulting meat emulsion is then extruded into a continuous slab or sheet that is further transferred into a steam tunnel where the slab/sheet is cooked by exposing it to heat. The cooked slab/sheet is then chopped into pieces, a sauce preparation or the like may be optionally added and the meat analogues packed and processed for sterilization.

DE 1020176125870 discloses an alternative process for the production of a meat analogue, comprising: a) introducing a meat batter which comprises protein into a first heating unit and heating the meat batter to a temperature above the denaturation temperature of the protein in the meat batter, but below the melting point of the protein to produce a first heat-treated product, and b) transferring the first heat-treated product to a second heating unit and heating the first heat-treated product to a temperature above the melting temperature of the protein to produce a second heat-treated product, c) cooling the second heat-treated product by moving through a cooling unit, so that the second heat-treated product has a temperature below water boiling temperature at ambient pressure when exiting the cooling unit, and d) dividing the cooled second heat-treated product into pieces.

In this process, moisture release coming from the use of fresh or thawed meats, when heated to above 140° C., is compensated by plant protein, such as wheat gluten, ab/adsorbing this and enabling the formation of a homogeneous chunk after cooling.

Thus, protein melting chunks as prepared above require plant protein powders, such like wheat gluten, corn gluten, soy protein concentrates or other plant protein isolates, in order to achieve the right protein content to form a melt that is structured when the melt passes through a cooling device, bringing the temperature of the melt down to below about 105° C. to avoid expansion of the water in the mixture, when released into atmospheric pressure. Wheat and corn gluten are unfavourable ingredients for some consumers. When simply removing gluten and only heating meats, the release of inherent water would result in meat debris like heated, ground meat in the “Bologna” style sauce.

The invention provides a novel process for the production of a textured meat analogue that substantially contains proteins deriving from meat and meat by-products, but comprising a lower content of plant proteins than methods known in the art.

Advantageously, the process of the invention enables meat analogues to be prepared from meat batter enriched in fibers and/or starches in order to produce authentic fibrous textured meat analogues while very low protein contents like in non-textured meat formulations can be realized. Compared to the use of plant protein, such as wheat gluten, in significant amounts, much smaller quantities of fibers, starches and egg powder may be included, thus allowing more meat material to be included, leading to meaty chunks. The inventive process allows the use of a minimum of fiber addition at a low protein content.

The invention provides a process for the production of a meat analogue, comprising the steps of:
a) introducing a meat batter comprising
   i) animal protein other than egg powder,
   ii) plant fiber and/or starch, and
   iii) egg powder,
      into a heating unit and heating the meat batter to a temperature above the melting point of the protein to produce a heat-treated product,
b) cooling the heat-treated product by moving it through a cooling unit, so that the heat-treated product has a temperature below water boiling temperature at ambient pressure when exiting the cooling unit, and
c) dividing the cooled heat-treated product into pieces.

The invention also provides a meat batter comprising
animal protein other than egg powder,
plant fiber and/or starch, and
egg powder.

The invention also provides a meat analogue which is obtainable by the process of the present invention.

Further embodiments of the inventive process, the meat batter and the meat analogue may be taken from the dependent claims.

The use of egg powder, plant fiber and/or starch provides a meat batter having a synergistic effect using a minimum of fibers. When only plant fiber and/or starch is used, significantly higher quantities of these constituents are necessary, resulting, however, in a low caloric density and in a high wet faeces output.

For the heating unit, all forms of heating to result in a melting of the protein will work. In one embodiment, the heating unit may comprise a microwave heating unit, a radio frequency heating unit, an ultra sound heating unit, a tubular, a scraped surface heat exchanger, an extruder, a twin or planetary screw extruder or an Ohmic heating unit.

The heating unit may be a single heating unit or may be a heating unit comprising two or more heating units which could be arranged in series. In the case of several heating units, it is only necessary that the meat batter is, finally, heated to a temperature of about 140° C. to about 170° C., i.e. above the melting point of the protein. In this regard, it has to be noted that for each protein (animal and plant protein) the denaturation and the melting point is specific. Thus, in a real product, it has to be dealt with a mixture of various proteins so that temperature ranges for denaturation and melting can be observed. Methods of measuring the melting range for the proteins used are given below.

In one embodiment, the process may include the additional step of preparing a meat batter by adding all ingredients into a mixer. In one embodiment, the meat batter may be conveyed by means of a positive displacement pump to the heating unit.

In one embodiment, the heat-treated product may be transferred to the cooling unit by means of a positive displacement pump.

When used herein the term “meat analogue” refers to a meat substitute suitable for use in pet or animal food as a meat replacement, which may suitably be a “chunk”. The meat analogue may have sensory attributes similar to cooked meat. Meat analogues may be incorporated into pet or human food products. They are particularly suitable for inclusion in wet pet food products of all types, e.g. they can be incorporated into pates, loaves and chunk in sauce formats. They are particularly suitable for inclusion in “chunk in sauce” products, e.g. “chunk and gravy”, “chunk and jelly” or “chunk and mousse” products. The meat analogues are typically between about 13 mm and about 20 mm in length along the longest dimension. They may suitably have a nutrient composition of about 55-65 wt % moisture, preferably 60-65 wt %, about 12-28 wt % protein, preferably 15-18 wt % protein, and 8-16 wt % fat, preferably 8-12 wt %, based on the total weight of the meat analogue.

When used herein the term “meat batter” refers to a thick mixture of water and other substances derived from raw materials, such as meat or meat by products. They are not emulsions such as mayonnaise or milk, but are dispersions of fat particles and air bubbles in a complex phase composed of water, solubilized meat protein, cellular components and other ingredients. They may also be referred to as a meat emulsion or a meat slurry. These terms are well understood in the art and are used interchangeably. Typically they comprise a continuous phase which is an aqueous medium containing soluble proteins, soluble muscle constituents, segments of muscle fibers, connective tissue fibers, bones etc. Meat batters/emulsions/slurries may also contain further additives as is common in the art. Meat batters can be obtained by known methods, e.g. by fragmenting frozen meat obtained from animal skeletal muscle to generate meat fragments which may be blended with water, one or more binding agent(s), and optionally other ingredients. Frozen meat is suitably chopped, crushed and ground to create a meat batter/slurry/emulsion. Typically the ground meat slurry will be size-reduced by use of a system comprising rotating and static elements, for example by means of rotating knives on die plates, and finally passes through a hole of characteristic diameter. In various embodiments, the maximum diameter of the hole is about 0.5 mm, about 1 mm, about 2 mm, about 3 mm, about 4 mm, about 5 mm, about 6 mm, about 7 mm, about 8 mm, about 9 mm, and/or about 10 mm. The resulting finer ground meat emulsion can suitably be transferred to a mixer where water, dry ingredients and liquid ingredients (e.g. colourants) can be optionally added to provide a meat batter.

When used herein, the term “animal protein” includes any protein of animal origin (including vertebrate and invertebrate proteins), e.g. proteins derived from mammals, fowl, fish and insects. Examples of suitable animal proteins include those derived from chicken, turkey, beef, lamb, pork, venison, buffalo, duck, kangaroo, shellfish, crustaceans, salmon, tuna, whitefish etc. They may suitably be derived from muscle meat, organs, tendons, bone, etc.

The plant fiber is in one embodiment selected from cellulose powder, sugar beet pulp powder, pectin containing materials, such as apple pomace and citrus fiber, and mixtures thereof.

The egg powder may suitably be full egg powder, egg white powder, egg yolk powder or mixtures thereof.

In certain embodiments the meat batter comprises plant protein in a maximum content of 40 wt %, based on the total weight of the meat batter. The meat batter preferably comprises plant protein in a maximum content of 40 wt %, 35 wt %, 30 wt %, 25 wt %, 20 wt %, 15 wt %, 10 wt%, 5 wt %, 3 wt % based on the total weight of the meat batter. The meat batter suitably comprises plant protein in an amount of less than 10-20 wt %, based on the total weight of the meat batter; less than 10-15 wt %, based on the total weight of the meat batter; less than 5-15 wt %, based on the total weight of the meat batter; less than 5-10 wt %, based on the total weight of the meat batter; less than 3-10%, based on the total weight of the meat batter or less than 3-5 wt %, based on the total weight of the meat batter. Plant proteins are well known in the art and may be selected pea proteins, potato proteins, soy proteins, wheat gluten, corn gluten, oil seed press cakes, soy protein concentrates or plant protein isolates. The plant protein is preferably plant isolate, more preferably pea isolate or potato isolate, most preferably pea isolate.

In one embodiment, the meat batter is gluten free. In another embodiment the meat batter is grain free. In yet another embodiment the meat batter is soy free. The meat matter may also be gluten free and grain free; gluten free and soy free; grain free and soy free or it may be gluten, grain and soy free. Especially cellulose powder, sugar beet pulp and full egg powder are well known in the art to ab/adsorb high amounts of water. For example, sugar beet pulp does absorb about 4 times its own weight of water, cellulose powder does absorb about 5 times the own weight of water, and full egg powder does absorb about 1.9 times the own weight of water, when heated to a temperature above 140° C. The amounts of these ingredients can be selected and adjusted, so that water released from the used meats during processing can be absorbed/adsorbed, respectively, in order to obtain homogeneous continuous chunks out of the cooling unit. In one embodiment, the meat batter is free of plant protein.

The first and second heating units in one embodiment may suitably be any heating system known in the art, e.g., they may suitably comprise a high shear emulsifier, a heat exchanger or a dielectric heater. In some embodiments at least one of the first and second heating units comprises a heat exchanger, preferably a scraped surface heat exchanger. When used herein, the term “scraped surface heat exchanger” refers to a mechanical device having a heated surface and a device for dislodging material from the heated surface by scraping. An example of a suitable scraped surface heat exchanger comprises a tubular device with a heated jacket surrounding its outer wall, through which heat is transmitted. Such a tubular device can include a center rotor with scrapers fixed to it. When such a center rotor rotates the scrapers remove product from the inner wall of the tubular device. In use, a mixture of ingredients can be fed into one end of the tubular device and pushed through the device. The heating and the motion through the annular space between the heated inner wall of the cylinder and the center rotor results in a transformation of the mixture. Scraped surface heat exchangers have the advantage of moving the ingredient mixture constantly through a pipe or similar hollow cylinder that is arranged such that heat is applied to its external surface. This can be accomplished by encasing the pipe or cylinder in a water bath that can be maintained at a desired temperature, e.g., by encasing the pipe or cylinder in a thermal agent medium, steam chamber, themo-oil or other suitable heated medium that can be maintained at the desired temperature. Also the use of an external electrical heated outer temperature source is possible. The temperature difference between the interior and exterior of the scraped surface heat exchanger causes the ingredient mixture to be heated through indirect heating. Scraped surface heat exchangers are well known in the art. In preferred embodiments both the first and the second heating units comprise a heat exchanger, preferably they both comprise a scraped surface heat exchanger.

In one embodiment, the second heating unit may comprise a microwave heating unit, a radio frequence heating unit or an Ohmic heating unit, the use thereof may reduce the residence time of the first heat-treated product in the second heating unit.

In another embodiment, the process of the invention may comprise the use of additional heating units, for example a heating unit before step a) for heating the meat batter to a temperature below the denaturation temperature of the protein, and/or a further heating unit between step a) and step b) for further heating the first heat-treated product below the melting temperature of the protein.

In another embodiment, two or more heating units may be operated in parallel in one process step. In another embodiment, two or more heating units may be also operated in series in one process step.

When the meat batter enters the first heating unit it may suitably have a temperature of about 10-35° C., preferably 15-25° C. The slurry can suitably be pumped into the unit at about 800 — 2000 kPa, preferably 1000-1250 kPa and heated as it passes through the unit, e.g., by supplying a heat jacket with steam. In some embodiments the meat batter is heated in the first heating unit to a temperature of about 90° C. to about 120° C.; about 100° C. to about 120° C.;

about 90° C. to about 115° C.; about 100° C. to about 115° C.; about 90° C. to about 110° C.; or about 100° C. to about 110° C. In further embodiments the first heat-treated product is heated in the second heating unit to a temperature of about 140° C. to about 170° C.; about 145° C. to about 170° C.; about 150° C. to about 170° C.; about 155° C. to about 170° C.; about 160° C. to about 170° C.; about 140° C. to about 165° C.; about 145° C. to about 165° C.; about 150° C. to about 165° C.; 155° C. to about 165° C. or about 160° C. to about 165° C. The ratio of residence time of the batter in the first heating unit to the residence time in the second heating unit is suitably from about 3:2 to about 14:2, preferably from about 3:2 to about 7:2, more preferably from about 4:2 to about 6:2. In some embodiments, the pressure in the first heating unit and the pressure in the second heating unit exceeds the water vapor pressure at the respective local temperature. In some embodiments the pressure in the first heating unit and the pressure in the second heating unit are substantially equal and are preferably in a range between about 800 to about 2000 kPa; about 800 to about 1,800 kPa; about 1,000 to about 1,800 kPa; about 1,000 to about 1,500 kPa; more preferably between about 1000 kPa to about 1250 kPa. This pressure range allows efficiency of energy transfer and reduction of wear of the equipment, for example the scrapers in a scraped surface heat exchanger. The second heat-treated product may suitably be divided into pieces at a temperature of about 40° C. to about 80° C.; about 40° C. to about 70° C.; about 50° C. to about 80° C.; about 50° C. to about 70° C.

The meat batter utilized in the inventive process typically comprises a mixture of proteins having differing denaturation temperatures and melting temperatures. Preferably substantially all the protein in the meat batter is denatured in the first heating unit. Preferably in the second heating unit at least 50 wt %, 60 wt %, 70 wt %, 80 wt % or 90 wt % of protein, based on the total amount of protein in the meat batter, is melted. Most preferably substantially all the protein is melted. In one embodiment, it is only necessary that enough protein is melted to form a cohesive and continuous outer phase of the second heat-treated product that may carry non-melted other proteins, fibers, bone particles, etc.

When used herein, the term “denaturation” related to proteins means that denatured proteins have lost their three-dimensional structure. Denatured proteins may exhibit a wide range of characteristics, from loss of solubility to protein aggregation. Someone skilled in the art is well aware what is to be understood under a denatured protein.

When used herein, the melting point of a protein is the temperature at which it changes state from solid to liquid at the pressure selected.

The denaturation temperature of a protein may be measured by methods well known in the art, for example by use of a rubber process analyzer. As a rubber process analyzer, a respective analyzer from TA Instruments, Wetzlar, Germany, Model RPA Elite, may be used, measuring viscoelastic properties of protein/moisture samples pursuing a temperature sweep analysis delivering a protein melting range.

Concerning the melting range for the proteins used, rheological measurements may be utilized, wherein the melting range is the temperature range, where after an increase in viscosity due to the denaturing (unfolding) of the proteins a drop of viscosity is observed indicating a change from a suspension of solids into a homogeneous liquid phase. The overall liquidity of the mixture will determine whether it can be solidified in layers. In one embodiment, more than 50% of the proteins should be molten within the mixture. The minimum in viscosity will be determined by the liquid state of all proteins. This can be measured as well in an ordinary rheometer, that is magnetically coupled with a spindle inside a pressure cell (Anton Paar Rheometer).

Also the melting point of a protein may be measured by methods well known in the art, for example by differential scanning calorimetry (DSC).

For individual proteins, respective data of denaturation temperature and melting point can be also obtained from scientific literature.

The heat-treated product is suitably a layered and/or aligned product formed as the material cools in step (c). As the melted material solidifies a layered fibrous meat analogue structure is formed. Steps (c) and/or step (d) is optionally performed under pressure of about 800-2000 kPa, so that the protein solidifies step by step in layers which create a fibrous structure. Thus, in the cooling step the aggregate of the protein changes from a liquid melt to a solid phase.

In other words, the protein setting is the controlled solidification of melted protein. The formation of meat-like fibers is the direct result of an appropriately controlled cooling. As described above, if the first heat-treated product has been heated above the melting point of the protein, at least part of that protein (or the protein mixture) is said to be melted. Once proteins have been brought to the melted state, upon cooling, they will solidify into a strong, elastic mass with leather-like properties. This mass does not easily re-melt and cannot easily be pumped mechanically. Thus, it is important that, once melted, protein is maintained in motion and cooled in a cooling unit from which solidified material can be continuously discharged.

The heat-treated product exits the heating unit at e.g. 140° C. to about 170° C. and is cooled to a temperature preferably below water boiling temperature in a cooling unit, e.g. using a tubular cooling zone cooled with water. Also, a rectangular shaped cooling die design may be used. The product is transferred through the unit, e.g., along a cool surface, and forms into a layered fibrous structure as the melt solidifies (as the product temperature drops below its melting point). This occurs under pressure and in motion and the protein solidifies step by step in layers to create fibrous structures.

When used herein the term “dividing” refers to any operation to comminute the heat-treated product, for example cutting, ripping, tearing, squeezing, hammer milling, etc. This may suitably be performed using a grid or rotary cutting device. Dividing may be performed in one or more steps, for example a first cutting may be performed using a grid cutter followed by a second cutting using a rotary cutter. The resulting meat analogues are irregular, random or essentially random in shape. Optionally, they can be transferred to an inspection station for visual inspection to facilitate quality control, manual or automatic, e.g., using a digital camera and suitable image recognition software.

Also provided is an apparatus for the production of a meat analogue. The apparatus may comprise:
i) a transfer means, for example a positive displacement pump, for transferring a meat batter into the heating unit,
ii) a heating unit being operable to heat the meat batter to a temperature above the melting temperature of the protein,
iii) a further transfer means, for example a positive displacement pump, for transferring the heat-treated product to a cooling unit,
iv) the cooling unit located downstream the heating unit and operable to cool down the heat-treated product obtained from the heating unit below water boiling temperature at ambient pressure when exiting the cooling unit, and
v) a dividing unit located downstream the cooling unit suitable for dividing cooled down heat-treated product obtained from the cooling unit into pieces.

The apparatus may also additionally comprise one or more of:
i) a grinder for grinding meat,
ii) a mixer,
iii) an emulsifying unit or a batter pump installed upstream of the transfer means,
iv) a conditioning unit,
v) a packaging unit, and
vi) a sterilization unit installed downstream of the heating unit.

The transfer means may suitably be a pump or the like which allows transfer of the meat batter, and the heat-treated product through all steps of the apparatus. If necessary further transfer means may be provided, for example between the first heating unit and the second heating unit, between the second heating unit and the cooling unit or between the cooling unit and the dividing unit. The further transfer means may be also any type of a pump or the like. Preferably the processes of the invention do not utilise and/or comprise a steam tunnel.

The heating unit, preferably the first and/or the second heating unit(s), may suitably be slightly tilted. In such embodiments the heat-treated product preferably enters the heating unit(s) from below, allowing air to be forced out of the units, ensuring improved heat transfer.

Further features and advantages of the invention are illustrated in the following examples, which are not intended to be limiting in any way.

### EXAMPLE 1

A meat batter of the following composition was prepared, wherein the below given amounts are weight percentages, based on the total weight of the meat batter:

| | |
|---|---|
| chicken liver | 28.000 |
| pork spleens | 11.518 |
| chicken (mechanical deboned meats = separated muscle fibers) | 40.000 |
| cellulose powder | 4.180 |
| beet pulp fiber | 4.180 |
| egg whole powder | 10.173 |
| minerals, vitamins, etc. add up to 100 | |

The mixture was continuously fed at a rate of 4 kg/min into a first SSHE unit with a volume of approx. 17 L and a surface to volume ratio of 60 m²/m³ under 1,200 kPa product pressure. The first SSHE unit was continuously supplied with steam at a temperature between 134-136° C. and the shaft operated at 200rpm. The outlet temperature of the material from this heating unit was between 109 and 111° C. The material was immediately directed into a second SSHE unit with a volume of approx. 9.7 L and a surface to volume ratio of 60 m²/m³ under 1,200 kPa product pressure. The second SSHE unit was continuously supplied with steam at a temperature between 166-168° C. and the shaft operated at 300rpm. The outlet temperature of the material from this heating unit was between 158-160° C. The residence time in the two heating units was distributed as two-thirds in the first heating unit and one third in the second heating unit. The material was then directed to a cooling area through which its temperature was brought down to below 80° C. The solid material obtained was cut to produce meat analogues with internal fibrosity.

The features disclosed in the foregoing description and in the claims may, both separately and in any combination, be material for realizing the invention in diverse forms thereof.

1. A process for the production of a meat analogue, comprising the steps of:a)
introducing a meat batter comprising
i) animal protein other than egg powder,
ii) plant fiber and/or starch, and
iii) egg powder, into a heating unit and heating the meat batter to a temperature above the melting point of the protein to produce a heat-treated product,
b) cooling the heat-treated product by moving through a cooling unit, so that the heat-treated product has a temperature below water boiling temperature at ambient pressure when exiting the cooling unit, and
c) dividing the cooled heat-treated product into pieces.

2. The process of for the production claim 1, wherein, in step a), the meat batter is introduced into a first heating unit and the meat batter is heated to a temperature above the denaturation temperature of the protein in the meat batter, but below the melting point of the protein to produce a first heat-treated product, the first heat-treated product is then transferred to a second heating unit and the first heat-treated product is heated to a temperature above the melting point of the protein to produce a second heat-treated product.

3. The process of claim 1, wherein the meat batter comprises:
75-85 wt % meat and meat by-products as animal protein,
at least 7 wt % of plant fiber and/or starch, and
at least 8 wt % of egg powder,
based on the total weight of the meat batter.

4. The process of claim 1, wherein the egg powder is selected from full egg powder, egg white powder, egg yolk powder or mixtures thereof

5. The process of claim 1, wherein the plant fiber is selected from cellulose powder, sugar beet pulp powder, pectin containing materials or mixtures thereof.

6. The process of claim 1, wherein the meat batter comprises plant protein in a maximum content of 40 wt %, based on the total weight of the meat batter.

7. The process of claim 1, wherein the meat batter comprises plant protein in an amount of less than 10-20 wt %, based on the total weight of the meat batter.

8. A The process of claim 1, wherein the meat batter is gluten free, preferably grain and/or soy free.

9. The process of claim 2, wherein at least one of the first and second heating units comprises a scraped surface heat exchanger, preferably the first and second heating units both comprise a scraped surface heat exchanger.

10. A The process of claim 2, wherein the meat batter is heated in the first heating unit to a temperature of about 90° C. to about 120° C. and the first heat-treated product is heated in the second heating unit to a temperature of about 140° C. to about 170° C.

11. A meat batter, comprising:
animal protein other than egg powder,
plant fiber and/or starch, and
egg powder.

12. A meat analogue, obtainable by a process according to claim 1.
